(19) United States
(12) Patent Application Publication
(10) Pub. No.: US 2024/0320314 A1
(43) Pub. Date: Sep. 26, 2024

(54) CENTRALIZED VOICE BIOMETRIC ECU

(71) Applicant: Panasonic Automotive Systems Company of America, Division of Panasonic Corporation of North America, PEACHTREE CITY, GA (US)

(72) Inventors: KATHERINE JENNETTE FREUND, WIXOM, MI (US); ROBERT A. MUNSON, COMMERCE, MI (US); SAMEH TAWADROUS, SENOIA, GA (US)

(21) Appl. No.: 18/607,632

(22) Filed: Mar. 18, 2024

Related U.S. Application Data
(60) Provisional application No. 63/453,512, filed on Mar. 21, 2023.

(51) Int. Cl. G06F 21/32; G07C 9/00

(52) U.S. Cl. CPC G06F 21/32; G07C 9/00563; G07C 2009/00984

(57) ABSTRACT

A voice biometric system for a motor vehicle includes a microphone producing a microphone signal dependent upon a voiced utterance by a human user. A low power, fast booting electronic control unit is communicatively coupled to the microphone and performs voice biometric processing on the microphone signal to authenticate the human user. An application is communicatively coupled to the electronic control unit and receives a signal from the electronic control unit. The application modifies a parameter of the motor vehicle dependent upon the authentication of the human user by the electronic control unit.

### CROSS-REFERENCED TO RELATED APPLICATIONS

This application claims benefit of U.S. Provisional Application No. 63/453,512, filed on Mar. 21, 2023, the disclosure of which is hereby incorporated by reference in its entirety for all purposes.

### BACKGROUND OF THE INVENTION

### 1. Field of the Invention

The present invention relates to identifying human occupants of a motor vehicle.

### 2. Description of the Related Art

Current solutions for voice authentication require using different systems and system integrations for different use-cases. This creates complexity and increases latency. Current solutions have a very narrow scope for voice biometrics, using them only within specific applications and software programs.

### SUMMARY OF THE INVENTION

The invention may provide a low power, fast booting electronic control unit (ECU) that can house voice biometric processing to authenticate users and send user-approved/user-rejected information to other systems in the car. The ECU may be lower power and fast booting to enable real time processing for users even when the vehicle is off. The voice biometric ECU may boot prior to the rest of the vehicle systems, enabling its use as the user approaches the vehicle.

When a system in the vehicle wants to authenticate a user via voice biometrics, the system may send a request to the voice biometric ECU, along with an audio signal containing speech. The ECU routes the audio signal to the voice biometric algorithm to confirm whether the talker is a previously enrolled user and, if so, which user they are. The ECU communicates back to the requesting system, identifying which enrolled user spoke, if any.

Having all voice biometrics handled by a single unit eliminates voice biometric redundancies, reduces cost, and improves user satisfaction. A centralized voice biometric solution may require a user to enroll their voice only once, thereby reducing redundancies and user frustration. The present invention may provide voice biometrics without being tied to a specific application, thereby enabling use across all functionalities within and around the vehicle.

By having a dedicated ECU house and contain the voice biometrics instead of the voice biometrics being contained of the vehicle's in-vehicle infotainment (IVI) system, voice biometrics can be used without requiring the IVI to fully turn on (which can take a few seconds) and can more easily be used for non-IVI use cases. This may enable a more natural customer experience. IVI may still access voice biometric functionality.

The fast boot and low power consumption may enable streamlined use since the users are not required to wait before using their voice to confirm their identity. This enables use cases that operate before the vehicle turns on, and before an ignition of the vehicle is turned on, including lock/unlock, open/close doors, etc.

The invention comprises, in one form thereof, a voice biometric system for a motor vehicle, including a microphone producing a microphone signal dependent upon a voiced utterance by a human user. A low power, fast booting electronic control unit is communicatively coupled to the microphone and performs voice biometric processing on the microphone signal to authenticate the human user. An application is communicatively coupled to the electronic control unit and receives a signal from the electronic control unit. The application modifies a parameter of the motor vehicle dependent upon the authentication of the human user by the electronic control unit.

The invention comprises, in another form thereof, a voice biometric method for a motor vehicle, including producing a microphone signal dependent upon a voiced utterance by a human user. A low power, fast booting electronic control unit is used to perform voice biometric processing on the microphone signal to authenticate the human user. A parameter of the motor vehicle is modified dependent upon the authentication of the human user by the electronic control unit.

The invention comprises, in yet another form thereof, a voice biometric system for a motor vehicle. The system includes a microphone producing a microphone signal dependent upon a voiced utterance by a human user. A low power, fast booting electronic control unit is communicatively coupled to the microphone and performs voice biometric processing on the microphone signal to authenticate the human user. An application is communicatively coupled to the electronic control unit and receives the microphone signal. The application recognizes a command in the microphone signal. The application receives a user authentication signal from the electronic control unit. The application modifies a parameter of the motor vehicle dependent upon the recognized command, and the authentication of the human user by the electronic control unit.

### BRIEF DESCRIPTION OF THE DRAWINGS

The above-mentioned and other features and objects of this invention, and the manner of attaining them, will become more apparent and the invention itself will be better understood by reference to the following description of embodiments of the invention taken in conjunction with the accompanying drawings, wherein:

FIG. 1 is a block diagram of one embodiment of a centralized automotive voice biometric ECU arrangement of the present invention.

FIG. 2 is a flow chart of one embodiment of a centralized automotive voice biometric method of the present invention.

FIG. 3 is a flow chart of another embodiment of a centralized automotive voice biometric method of the present invention.

FIG. 4 is a flow chart of one embodiment of a voice biometric method of the present invention for a motor vehicle.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

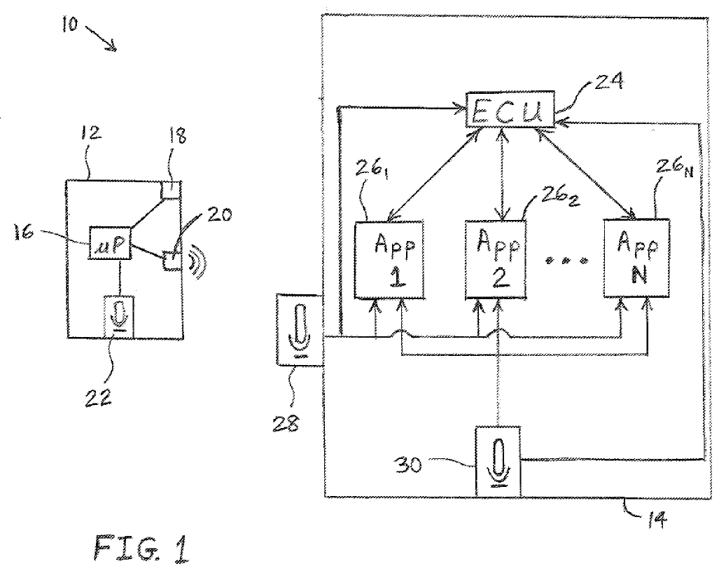

FIG. 1 illustrates one embodiment of a centralized automotive voice biometric ECU arrangement 10 of the present invention, including a key fob 12 and a motor vehicle 14. Key fob 12 includes an electronic processor 16 electrically connected to each of a lock/unlock pushbutton 18, a transponder 20, and a microphone 22.

Vehicle 14 includes a low power, fast booting electronic control unit (ECU) 24 electrically connected to each of N number of applications 26₁, 26₂, . . . , 26_{N} and to both an external microphone 28 and an internal microphone 30. ECU 24 may include an electronic processor and memory. Each of applications 26₁, 26₂, . . . , 26_{N} may include an electronic processor and memory, and may be electrically connected to both external microphone 28 and internal microphone 30. External microphone 28 may be mounted on the exterior of a body of vehicle 14 so that microphone 28 can pick up the voice of a person who is outside of vehicle 14. Internal microphone 30 may be mounted in the passenger compartment of vehicle 14 so that microphone 30 can pick up the voice of a person who is inside vehicle 14. Applications 26₁, 26₂, . . . , 26_{N} may be systems that need a user to be identified by their voice, such as, for example, a system that locks and/or unlocks vehicle doors, a system that opens and/or closes vehicle doors, a system that turns ON an ignition of vehicle 14, or a system that opens and/or closes a garage door.

During use, vehicle 14 may sense that key fob 12 is nearby or in close proximity (e.g., within 10 feet) in any conventional way, such as by use of a key proximity sensor, or by receiving a door unlock signal that transponder 20 of key fob 12 emits in response to the user pressing lock/unlock pushbutton 18. In response to the detecting that key fob 12 is nearby, ECU 24 is booted up such that ECU 24 may quickly access stored voice biometric data and compare a voice signal to the stored voice biometric data.

One of applications 26 and/or ECU 24 may need to verify that a voice signal received from one of microphones 22, 28 or 30 is from the voice of an enrolled or authorized user. The application 26 may transmit the voice signal to ECU 24, and ECU 24 may compare the voice signal to the stored voice biometric data. Alternatively, ECU 24 may receive the voice signal directly from one of the microphones 22, 28 or 30. If a set of the stored voice biometric data associated with a certain enrolled user matches characteristics of the voice signal, then ECU 24 transmits a signal to the application 26 indicating that the voice signal is from the voice of an enrolled or authorized user. However, if none of the sets of the stored voice biometric data associated the respective enrolled users matches characteristics of the voice signal, then ECU 24 transmits a signal to the application 26 indicating that the voice signal is not from the voice of an enrolled or authorized user.

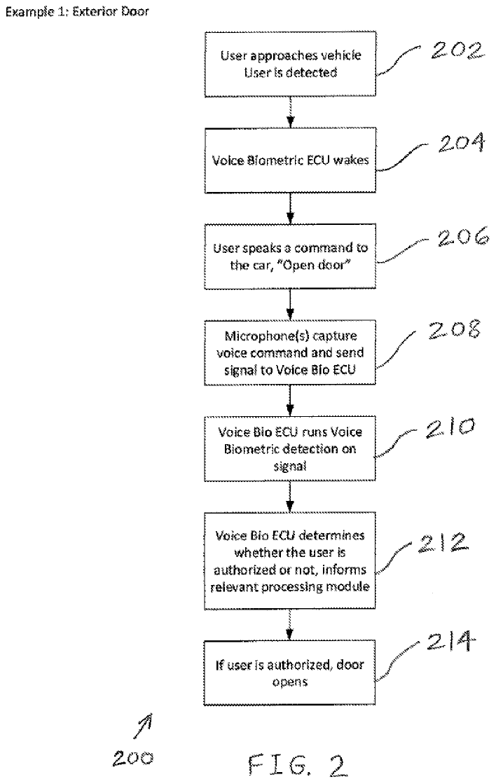

FIG. 2 illustrates one embodiment of a centralized automotive voice biometric method 200 of the present invention. In a first step 202, a user is detected as he approaches a vehicle. For example, the user may be carrying key fob 12, and vehicle 14 may include a key fob proximity sensor that detects when key fob 12 is within a predetermined distance of vehicle 14.

In a next step 204, a voice biometric ECU awakens. For example, ECU 24 may wake and boot up in response to the user being detected.

Next, in step 206, the user speaks a command to the car. For example, the user may say “Open door” to vehicle 14.

In step 208, one or more microphones capture the voice command and send a signal to the voice biometric ECU. For example, before the door is unlocked, microphone 22 or microphone 28 may pick up the voice command of the user, and send the resulting microphone signal to ECU 24 as well as to applications 26.

In a next step 210, the voice biometric ECU runs voice biometric detection on the signal. For example, ECU 24 may compare the microphone signal to sets of stored voice biometric data, with each set of data being associated with a respective enrolled or authorized user.

Next, in step 212, the voice biometric ECU determines whether the user is authorized or not, and informs the relevant processing module. For example, if ECU 24 ascertains that the microphone signal has characteristics that match a set of stored voice biometric data, then ECU 24 may determine that the user is one of the enrolled authorized users. However, if ECU 24 ascertains that the characteristics of the microphone signal do not match a set of stored voice biometric data, then ECU 24 may determine that the user is not one of the enrolled authorized users. After making the determination that the user is or is not one of the enrolled authorized users, ECU 24 may transmit a signal indicative of the determination to one or more of applications 26. For example, if the spoken command was “Open door,” then ECU 24 may send the signal to an application 26 that opens a door of vehicle 14.

In a final step 214, the door opens if the user is authorized. For example, if the application 26 that opens a door of vehicle 14 receives a signal from ECU 24 indicating that the user is one of the enrolled authorized users, then that application 26 may cause a door of vehicle 14 to open after application 26 also uses speech recognition to recognize the command “Open door”.

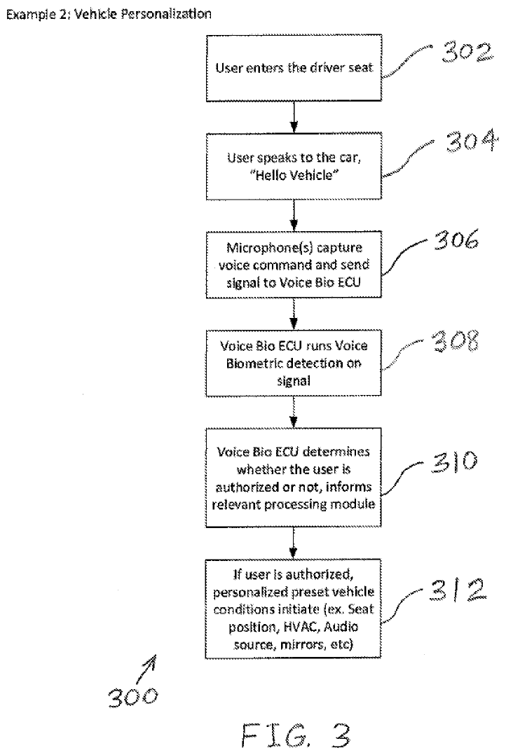

FIG. 3 illustrates another embodiment of a centralized automotive voice biometric method 300 of the present invention. In a first step 302, a user sits in the driver's seat. For example, a human user may get behind the wheel of vehicle 14.

In a next step 304, the user speaks to the car. For example, the user may say “Hello vehicle” to vehicle 14.

Next, in step 306, one or more microphones capture the user's voiced utterance and send a signal to a voice biometric ECU. For example, interior microphone 30 may pick up the audible statement by the user and send a corresponding microphone signal to voice biometric ECU 24.

In step 308, the voice biometric ECU runs voice biometric detection on the received signal. For example, voice biometric ECU 24 may compare the received microphone signal to sets of stored voice biometric data, with each set of data being associated with a respective enrolled or authorized user.

In a next step 310, the voice biometric ECU determines whether the user is authorized or not, and informs the relevant processing module. For example, if ECU 24 ascertains that the microphone signal has characteristics that match a set of stored voice biometric data, then ECU 24 may determine that the user is one of the enrolled authorized users. However, if ECU 24 ascertains that the characteristics of the microphone signal do not match a set of stored voice biometric data, then ECU 24 may determine that the user is not one of the enrolled authorized users. After making the determination that the user is or is not one of the enrolled authorized users, ECU 24 may transmit a signal indicative of the determination to one or more of applications 26.

In a final step 312, if the user is authorized, then personalized preset vehicle conditions initiate. For example, if one of applications 26 that receives the positive authorization signal from ECU 24 is a memory seat module, then, in response to receiving the positive authorization signal, the memory seat module may move the driver's seat to the stored seat position that is saved in memory in association with the identified authorized user. In addition to the signal from ECU 24 to the memory seat module indicating that the user is authorized, the signal may also indicate the specific identity of the authorized user. Other possible types of applications 26 that customize the conditions of vehicle 14 for specific individuals may include, for example, an HVAC module, audio source module, and a memory mirror position module.

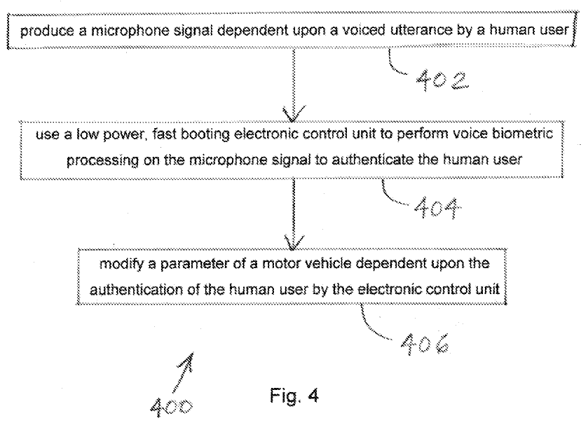

FIG. 4 is a flow chart of one embodiment of a voice biometric method 400 of the present invention for a motor vehicle. In a first step 402, a microphone signal is produced dependent upon a voiced utterance by a human user. For example, microphone 30 can pick up the voice of a person who is inside vehicle 14. Microphone 30 can then produce a microphone signal based on the voice.

Next, in step 404, a low power, fast booting electronic control unit is used to perform voice biometric processing on the microphone signal to authenticate the human user. For example, low power, fast booting electronic control unit (ECU) 24 may perform voice biometric processing on the signal from microphone 30 to authenticate the human user by determining that the microphone signal has characteristics that match a set of stored voice biometric data.

In a final step 406, a parameter of the motor vehicle is modified dependent upon the authentication of the human user by the electronic control unit. For example, the driver's seat may be moved to a memory seat position that has been stored in memory for the person whose voice has been identified and authenticated by ECU 24.

In an alternative embodiment, the ECU houses and performs automated speech recognition (ASR) in addition to voice biometrics. Thus, the ECU can interpret commands in addition to performing user authentication.

In another alternative embodiment, the ECU contains Bluetooth functionality, enabling users to connect their smart phones to enroll and manage user accounts.

In yet another alternative embodiment, the ECU has a low-power amplifier to enable users to receive audio feedback.

In one alternative embodiment, the ECU has a built-in microphone that can collect audio for voice biometric analysis. Thus, the ECU is not solely dependent on an audio signal being routed to the ECU from an external microphone.

In another alternative embodiment, instead of identifying specific “users”, the ECU tracks only their permission level, informing other systems if the talker is, for example, the owner, a limited user, or unknown.

In another alternative embodiment, the ECU also processes audio to identify different “sounds” for use in emergency vehicle detection.

In another alternative embodiment, the ECU forwards user information to E-Call systems or emergency services to aid in occupant identification.

In another alternative embodiment, the ECU is sent third party enrollment information to confirm the identities of ride-share users.

In another alternative embodiment, the ECU can confirm the occupant identities to federal authorities at Customs and Border stations when the vehicle crosses from one country into another.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A voice biometric system for a motor vehicle, the system comprising:
a microphone configured to produce a microphone signal dependent upon a voiced utterance by a human user;
a low power, fast booting electronic control unit communicatively coupled to the microphone and configured to perform voice biometric processing on the microphone signal to authenticate the human user; and
an application communicatively coupled to the electronic control unit and configured to:
receive a signal from the electronic control unit; and
modify a parameter of the motor vehicle dependent upon the authentication of the human user by the electronic control unit.

2. The system of claim 1 wherein the application is configured to modify a parameter of the motor vehicle dependent upon at least one word recognized in the spoken utterance.

3. The system of claim 1 wherein the low power, fast booting electronic control unit is configured to perform voice biometric processing on the microphone signal before the motor vehicle is turned on, and before an ignition system of the motor vehicle is turned on.

4. The system of claim 1 wherein the low power, fast booting electronic control unit is configured to perform voice biometric processing on the microphone signal before an in-vehicle infotainment system of the motor vehicle is turned on.

5. The system of claim 1 wherein the microphone is on a key fob.

6. The system of claim 1 wherein the microphone is mounted on an exterior of the motor vehicle.

7. The system of claim 1 wherein the microphone is in an interior of the motor vehicle.

8. A voice biometric method for a motor vehicle, the method comprising:
producing a microphone signal dependent upon a voiced utterance by a human user;
using a low power, fast booting electronic control unit to perform voice biometric processing on the microphone signal to authenticate the human user; and
modifying a parameter of the motor vehicle dependent upon the authentication of the human user by the electronic control unit.

9. The method of claim 8 wherein the modifying step is dependent upon at least one word recognized in the spoken utterance.

10. The method of claim 8 wherein the low power, fast booting electronic control unit performs the voice biometric processing on the microphone signal before the motor vehicle is turned on, and before an ignition system of the motor vehicle is turned on.

11. The method of claim 8 wherein the low power, fast booting electronic control unit performs the voice biometric processing on the microphone signal before an in-vehicle infotainment system of the motor vehicle is turned on.

12. The method of claim 8 wherein the microphone signal is produced by a microphone on a key fob.

13. The method of claim 8 wherein the microphone signal is produced by a microphone mounted on an exterior of the motor vehicle.

14. The method of claim 8 wherein the microphone signal is produced by a microphone in an interior of the motor vehicle.

15. A voice biometric system for a motor vehicle, the system comprising:
a microphone configured to produce a microphone signal dependent upon a voiced utterance by a human user;
a low power, fast booting electronic control unit communicatively coupled to the microphone and configured to perform voice biometric processing on the microphone signal to authenticate the human user; and
an application communicatively coupled to the electronic control unit and configured to:
receive the microphone signal;
recognize a command in the microphone signal;
receive a user authentication signal from the electronic control unit; and
modify a parameter of the motor vehicle dependent upon:
the recognized command; and
the authentication of the human user by the electronic control unit.

16. The system of claim 15 wherein the low power, fast booting electronic control unit is configured to perform voice biometric processing on the microphone signal before the motor vehicle is turned on, and before an ignition system of the motor vehicle is turned on.

17. The system of claim 15 wherein the low power, fast booting electronic control unit is configured to perform voice biometric processing on the microphone signal before an in-vehicle infotainment system of the motor vehicle is turned on.

18. The system of claim 15 wherein the microphone is on a key fob.

19. The system of claim 15 wherein the microphone is mounted on an exterior of the motor vehicle.

20. The system of claim 15 wherein the microphone is in an interior of the motor vehicle.
